(19) United States
(12) Patent Application Publication
(10) Pub. No.: US 2016/0327027 A1
(43) Pub. Date: Nov. 10, 2016

(54) MOBILE OFFSHORE WIND TURBINE

(71) Applicant: Cheng Ting, Chino Hills, CA (US)

(72) Inventor: Cheng Ting, Chino Hills, CA (US)

(21) Appl. No.: 15/215,514

(22) Filed: Jul. 20, 2016

Related U.S. Application Data
(63) Continuation-in-part of application No. 14/283,240, filed on May 21, 2014, now abandoned.

(51) Int. Cl. F03D 7/06; B63B 35/44; F03D 9/00; F03D 13/25; F03D 3/00; F03D 3/06

(52) U.S. Cl. CPC F03D 7/06; F03D 3/005; F03D 3/062; F03D 9/002; F03D 13/25; B63B 35/44; B63B 2035/446; G05D 1/0206

(57) ABSTRACT

A mobile offshore wind turbine may include a column, a base and a plurality of turbine blades. In one embodiment, the column is at a center piece of the base and a plurality of connecting rods radially extending from the column to connect with the turbine blade. The base may also include a side piece disposed on both sides of the center piece to increase the stability of the base. The turbine blade has a blade surface that resembles the shape of a sail, and the turbine blade is rotatably disposed on the corresponding connecting rod and vertically aligned with the column. In another embodiment, a sensing unit may be disposed on the turbine blade to detect the direction of the wind and transmit the detection signal to a control center to further control the moving direction of the mobile wind turbine.

### CROSS-REFERENCE TO RELATED APPLICATIONS

This application is a continuous-in-part (CIP) application of Ser. No. 14/283,240, filed on May 21, 2014 now pending, which is incorporated herein by reference.

### FIELD OF THE INVENTION

The present invention relates to offshore wind turbines, and more particularly to mobile offshore wind turbines that can be moved when the direction of the wind changes to enhance the electricity generation efficiency.

### BACKGROUND OF THE INVENTION

Offshore wind power refers to the construction of wind farms in bodies of water to generate electricity from wind. It has become increasingly difficult to find suitable locations for the wind farms on land. On many occasions, there has been a lot of opposition against placement of wind turbines due mainly to the noise produced by the wind turbines and aesthetic effects of the placement of wind turbines. Furthermore, for wind turbines to be able work efficiently, a windy and open area free from trees and buildings etc. is needed which is not always readily available.

Recently, it has become more popular to place wind turbines or wind parks in sea, either close to the coast (near-shore) or offshore. Larger areas can be available for offshore wind turbines, and the wind may be more constant and of higher velocity on sea than on land, and wind shear is generally reduced. Also, with reduced noise constraints, wind turbines can rotate at higher speeds.

Furthermore, offshore wind power can help to reduce energy imports, reduce air pollution and greenhouse gases, meet renewable electricity standards, and create jobs and local business opportunities. Also, the wind is much stronger off the coasts, and unlike wind over the continent, offshore breezes can be strong in the afternoon, matching the time when people are using the most electricity. Offshore turbines can also be “located close to the power-hungry populations along the coasts, eliminating the need for new overland transmission lines.

However, the offshore wind power is considered the most expensive energy generating technology due to the scale thereof. For example, for non-floating offshore wind turbines, the offshore repair and maintenance costs are high due to travel, distance, downtime and removal of such foundations after closure and decommissioning of the wind farm. Also, the non-floating offshore wind turbines can be vulnerable to bad weather conditions and by poor installation accessibility. Furthermore, fixed foundation offshore wind farms have only been used commercially in water depth up to about 30 meters, which can only harvest a small percentage of the globally available offshore energy.

More recently, floating wind turbines have been developed and used in deeper water further away from the shore. U.S. Pat. No. 8,471,396 to Roddier et al. (hereinafter “the '396 patent”) discloses a floating wind turbine platform including at least three columns and an active ballast system that moves water ballast between the columns to keep the tower vertically aligned, as shown in FIG. 1. Furthermore, the '396 patent discloses one or more additional features, such as an asymmetric mooring system and an active ballast system that facilitate production of a structure that can not only withstand environmental loads, but is also relatively light weight when compared to other platform designs and can lead to better economics for energy production. However, even for the floating wind turbines as disclosed in the '396 patent, the mobility thereof is very limited. Also, the manufacturing costs to build the floating wind turbines as shown in the '396 patent are still very high. Furthermore, the floating wind turbines may still be vulnerable to bad weather conditions.

As shown in FIG. 2, U.S. Pat. Pub. No. 2013/0266453 to Moiret discloses an offshore wind turbine foundation including a platform carrying a support for the wind turbine tower in its central region, and a plurality of leg guides in its peripheral region; and a plurality of legs which may be movable between a raised position for transport and lowered positions for resting on the seabed. Like the floating wind turbines disclosed in the '396 patent, the wind turbine discloses by Moiret also has limited mobility, which may lead to the vulnerability to bad weather condition. Therefore, there remains a need for a new and improved offshore wind turbine to overcome the problems stated above.

### SUMMARY OF THE INVENTION

It is an object of the present invention to provide a mobile offshore wind turbine that can be moved when the direction of the wind changes to enhance the electricity generation efficiency.

It is another object of the present invention to provide a mobile offshore wind turbine to reduce manufacturing costs thereof.

It is a further object of the present invention to provide a mobile offshore wind turbine that can be moved to a safer place to avoid being damaged by bad weather.

In one aspect, a mobile offshore wind turbine may include a column, a base and a plurality of turbine blades. In one embodiment, the column is at a center piece of the base and a plurality of connecting rods radially extending from the column to connect with the turbine blade. The base may also include a side piece disposed on both sides of the center piece to increase the stability of the base. The turbine blade has a blade surface that resembles the shape of a sail, and the turbine blade is rotatably disposed on the corresponding connecting rod and vertically aligned with the column.

In another embodiment, when the wind direction is substantially parallel to the blade surface of the turbine blades, the wind can actually drive the mobile wind turbine to move along the wind direction. It is noted a sensing unit may be disposed on the turbine blade to detect the direction of the wind and further transmit the detection signal to a control center, which is configured to control the orientation of the turbine blades to further control the movement of the mobile wind turbine.

In a further embodiment, when the wind direction is not substantially parallel to the blade surface of the turbine blades, each turbine blade can be driven by the wind to further drive the column to generate electricity. More specifically, the sensing unit on each turbine blade is configured to transmit the detection signal to the control center to change the direction of the blade surface corresponding to the wind direction, so that the turbine blade can continuously rotate to drive the column to maximize electricity production.

According to the embodiments described above, the present invention has the following advantages: (i) the offshore wind turbine can be moved when the wind direction is substantially parallel to the blade surface of the turbine blades. The wind can actually drive the wind turbine to move along the direction of the wind; (ii) the sensing unit is disposed on each turbine blade to transmit the signal to change the orientation the turbine blade to the control center, which is configured to change the orientation of the blade surface of the turbine blade, so that the turbine blade can continuously rotate to drive the column, the shaft, and the generator to maximize electricity production; and (iii) when the weather condition changes, the sensing unit can be actuated to send the signal to the control center again to move the wind turbine to a safer place to avoid being damaged by bad weather.

### BRIEF DESCRIPTION OF THE DRAWINGS

FIG. 1 is a prior art disclosing a floating wind turbine platform including at least three columns and an active ballast system that moves water ballast between the columns to keep the tower vertically aligned.

FIG. 2 is another prior art disclosing an offshore wind turbine foundation.

FIG. 3 illustrates a schematic top view of the mobile offshore wind turbine in the present invention.

FIGS. 4 to 5 illustrate a schematic view of the mobile offshore wind turbine in the present invention when the wind turbine is moving along the wind direction.

FIGS. 6 to 8 illustrate a schematic view of the mobile offshore wind turbine in the present invention when the turbine blades are rotating to generate electricity.

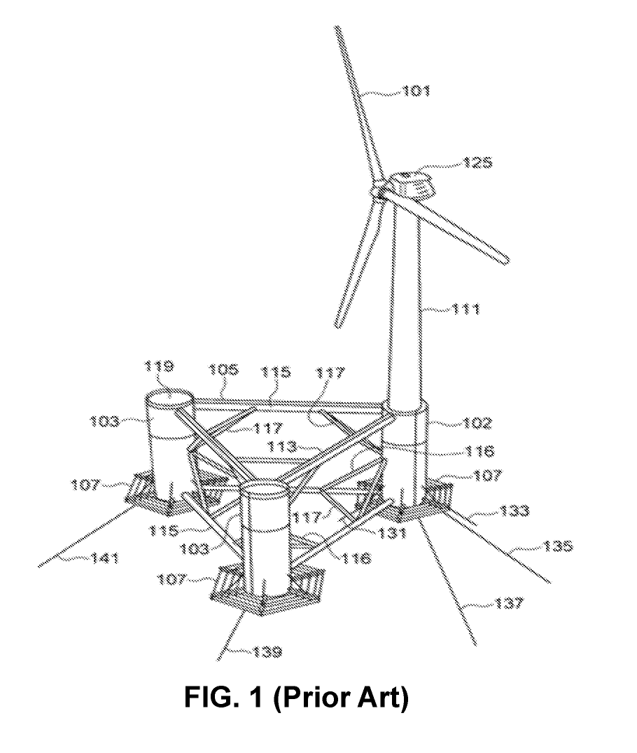

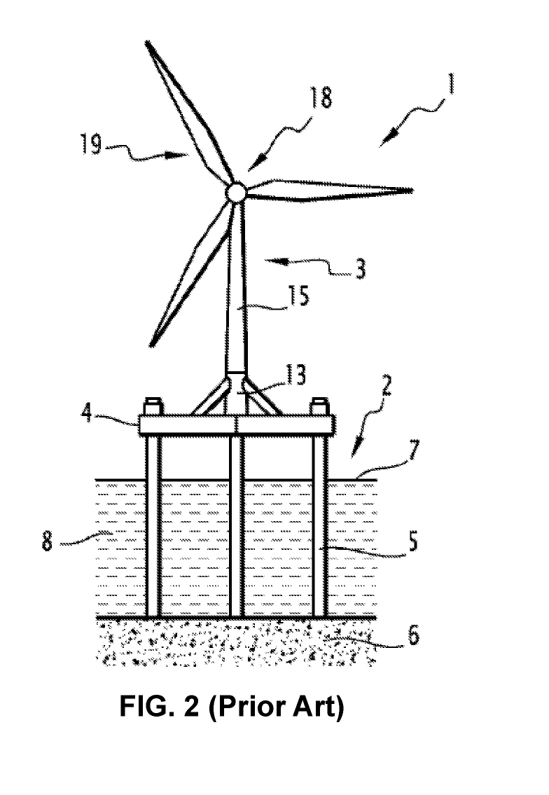

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As stated above, floating wind turbines have been developed and used in deeper water further away from the shore. However, the mobility of the floating wind turbine is very limited and the manufacturing cost thereof is still high. Also, due to the limited mobility, the floating wind turbine is vulnerable to bad weather conditions. In order to further understand the goal, characteristics and effect of the present invention, a number of embodiments along with the drawings are illustrated as following:

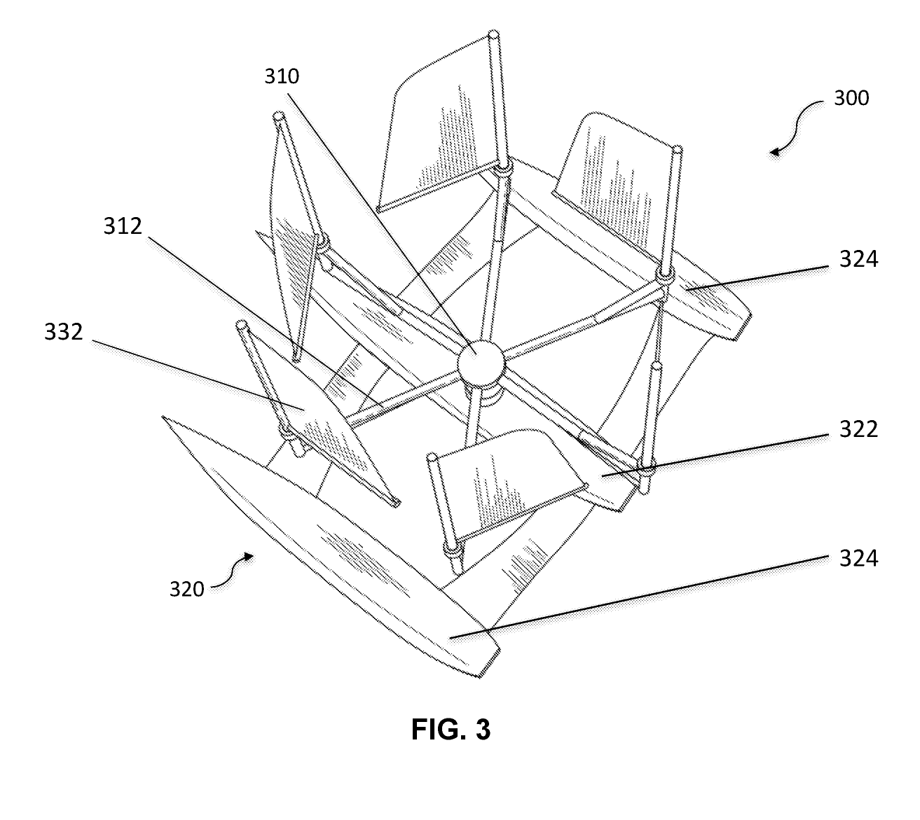

Referring to FIG. 3, in one aspect, a mobile offshore wind turbine 300 may include a column 310, a base 320 and a plurality of turbine blades 330. In one embodiment, the column 310 is at a center piece 322 of the base 320 and a plurality of connecting rods 312 radially extending from the column 310 to connect with the turbine blade 330. The base 320 may also include a side piece 324 disposed on both sides of the center piece 322 to increase the stability of the base 320. The turbine blade 330 has a blade surface 332 that resembles the shape of a sail, and the turbine blade 330 is rotatably disposed on the corresponding connecting rod 312 and vertically aligned with the column 310.

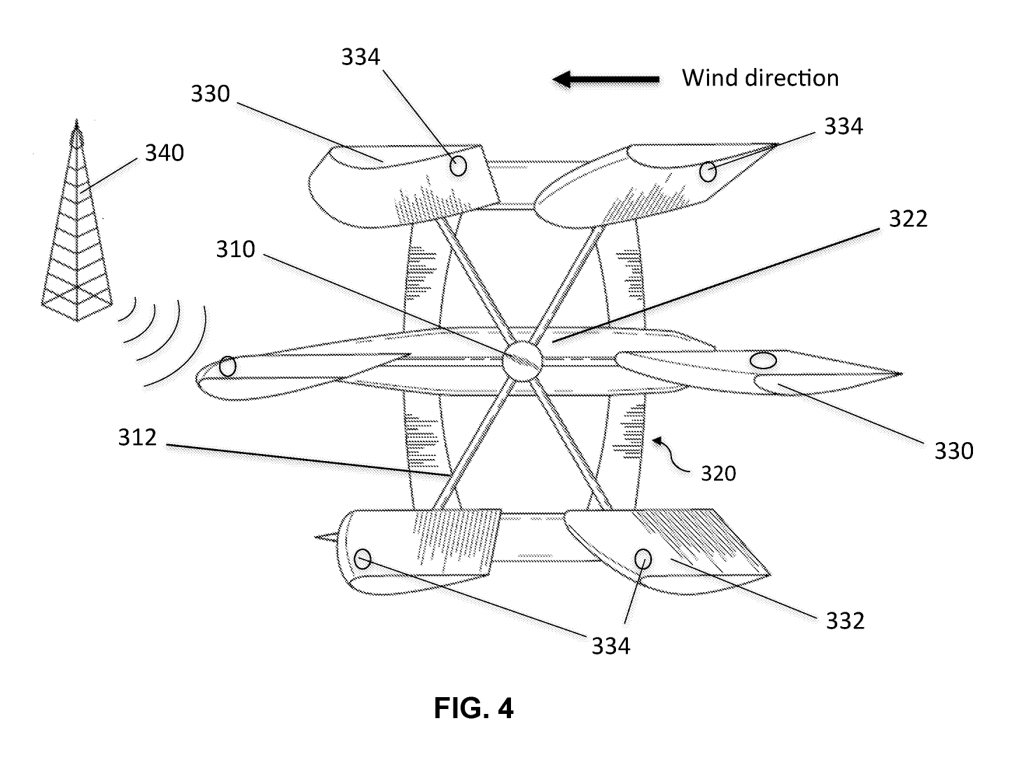

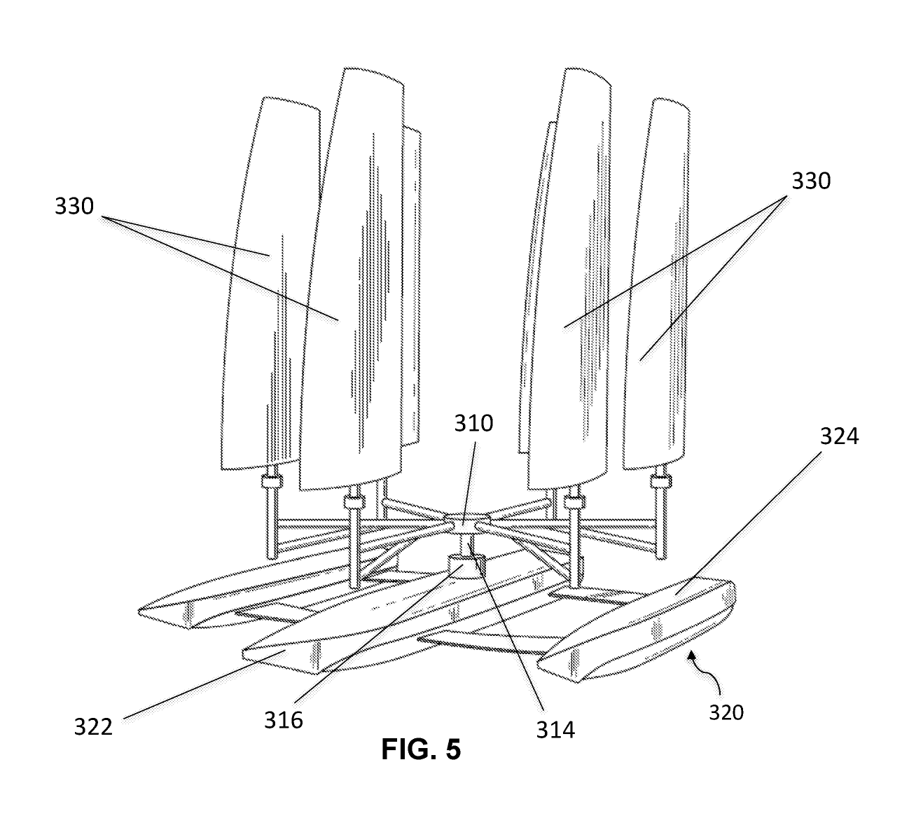

Referring to FIGS. 4 and 5 for another embodiment, when the wind direction is substantially parallel to the blade surface 332 of the turbine blades 330, the wind can actually drive the mobile wind turbine to move along the direction of the wind. It is noted a sensing unit 334 may be disposed on the turbine blade 330 to detect the direction of the wind and a signal of each sensing unit 334 to change the orientation of the turbine blade 330 will be transmitted to a control center 340, which is configured to remotely control the moving direction of the mobile wind turbine 300. In one embodiment, the signal transmission, either from the sensing unit 334 to the control center 340 or vice versa) can be achieved by using WIFI or other wireless long-range transmission technologies. In another embodiment, the sensing unit can transmit the detection results to a control center 340 that can incorporate the detection results and the weather condition to generate an optimized route for the mobile wind turbines. It is noted that a shaft 314 is connected to the column 310 and a generator 316 on the mobile wind turbine 300, so when the column 310 is rotated by the turbine blades 330, the shaft 314 can be driven by the column 310 to enable the generator 316 to generate electricity. In one embodiment, the electricity generated by the offshore turbine in the present invention can be transmitted through submarine cables.

It is important to note that the mobile wind turbine 300 in the present invention can be moved without any an external power source. Namely, when the wind direction is substantially parallel to the blade surface 332 of the turbine blades 330, the wind can actually drive the mobile wind turbine 300 to move along the direction of the wind, which is especially advantageous when the offshore wind turbines have to be moved to a safer place to avoid being damaged by bad weather.

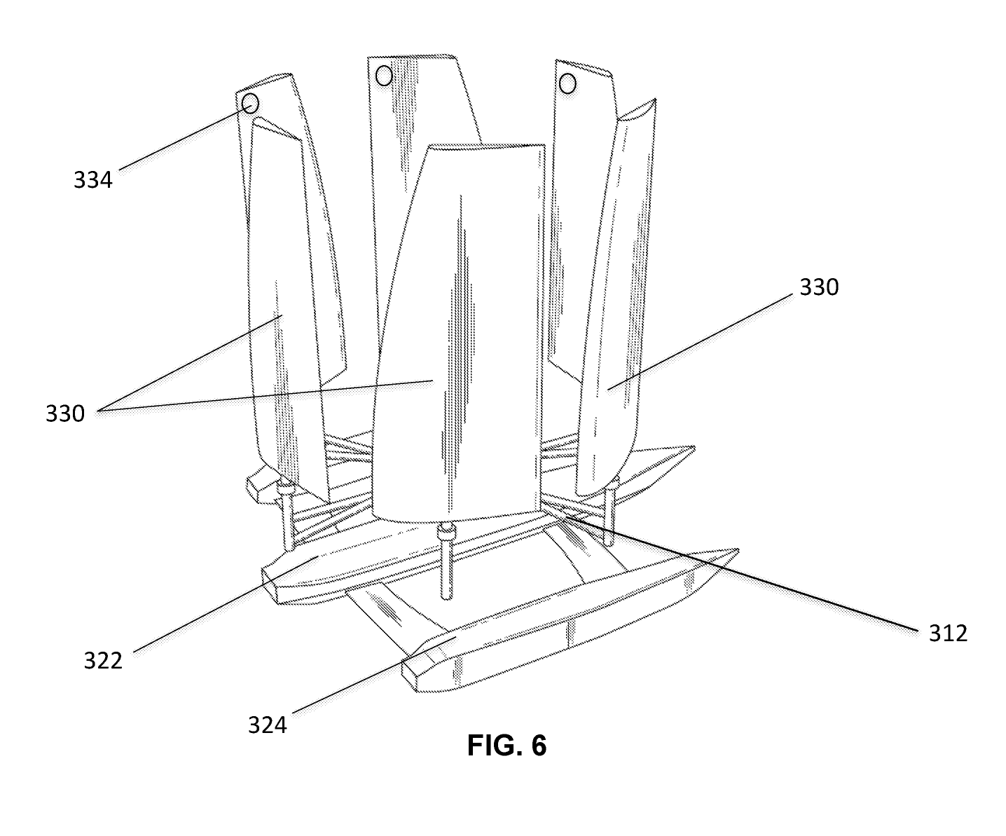

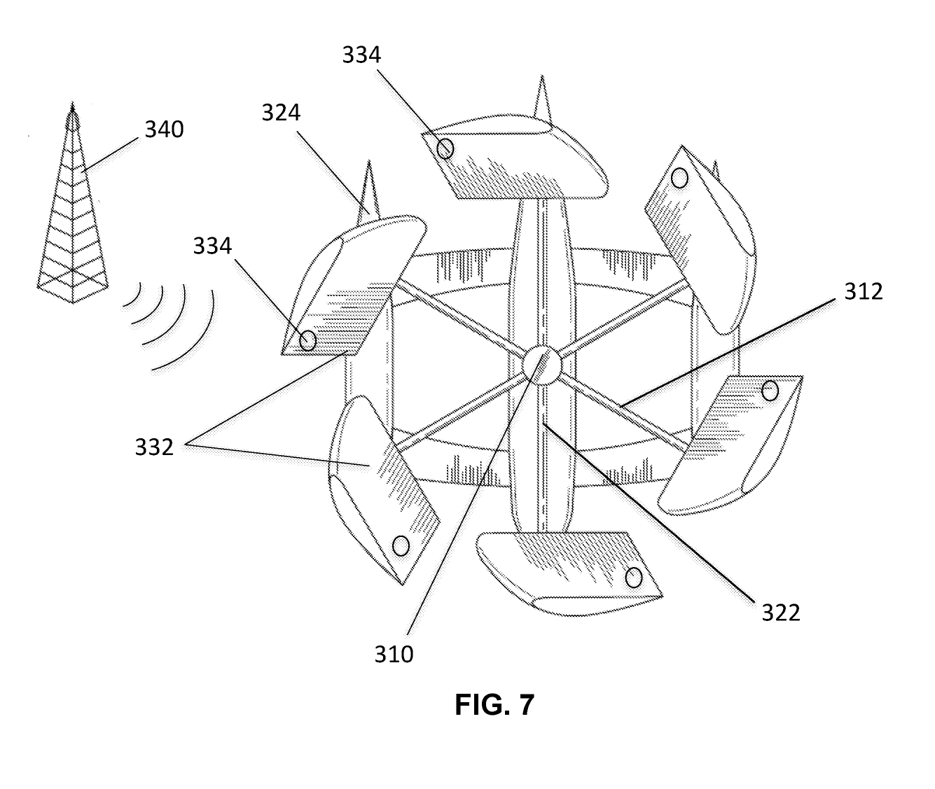

Referring to FIGS. 6 to 8 for a further embodiment, when the wind direction is not substantially parallel to the blade surface 332 of the turbine blades 330, each turbine blade 330 is driven by the wind to further drive the column 310 to generate electricity. More specifically, the sensing unit 334 on each turbine blade 330 is configured to transmit a signal to the control center 340, which is configured to remotely change the orientation of the blade surface 332 corresponding to the wind direction, so that the turbine blade 330 can continuously rotate to drive the column 310 to maximize electricity production.

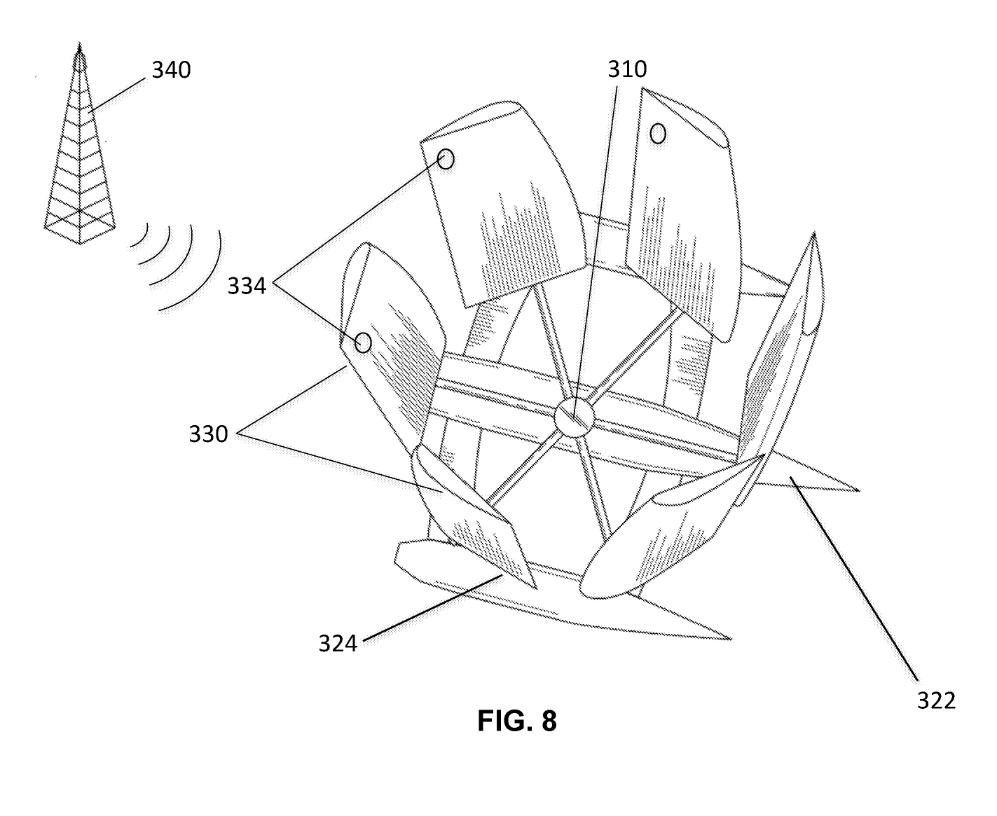

When the weather condition changes, the sensing unit 334 can detect the wind direction and transmit the signal to change to the control center 340, which may then change the blade surface 332 from FIG. 8 to FIG. 3, so that the wind turbine 300 can accordingly move along the wind direction to a safer place to avoid being damaged by the bad weather. In an exemplary embodiment, the sensing unit 334 on each turbine blade 330 can be collectively controlled by the control center 340, so that the movement of the mobile wind turbine can be well managed.

According to the embodiments described above, the present invention has the following advantages: (i) the offshore wind turbine 300 can be moved when the wind direction is substantially parallel to the blade surface 332 of the turbine blades 330. The wind can actually drive the wind turbine 300 to move along the direction of the wind; (ii) the sensing unit 334 is disposed on each turbine blade 330 to transmit the signal to change the orientation the turbine blade 330 to the control center 340, which is configured to change the orientation of the blade surface 332 of the turbine blade 330, so that the turbine blade 330 can continuously rotate to drive the column 310, the shaft 314, and the generator 316 to maximize electricity production; and (iii) when the weather condition changes, the sensing unit 334 can be actuated to send the signal to the control center 340 again to move the wind turbine 300 to a safer place to avoid being damaged by bad weather.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A mobile offshore wind turbine comprising:
a base that has a center piece and two side pieces disposed on both sides of the center piece;
a column disposed at the center piece of the base connecting with a shaft that connects with a generator;
a plurality of turbine blades having a blade surface on each turbine blade; and
a sensing unit disposed on the blade surface to detect wind direction,
wherein a plurality of connecting rods radially extending from the column to connect with the turbine blade, and the turbine blade is rotatably disposed on the corresponding connecting rod and vertically aligned with the column, and
wherein the sensing unit is configured to transmit a signal of the detected wind direction to a control center, which is configured to change an orientation of the blade surface of the turbine blade to control movement of the wind turbine.

2. The mobile offshore wind turbine of claim 1, wherein after receiving the detection signal from the sensing unit, the control center is configured change the orientation of the blade surface to be substantially parallel to the wind direction, so the offshore wind turbine is moves along with the wind direction without external power sources.

3. The mobile offshore wind turbine of claim 1, wherein after receiving the detection signal from the sensing unit that the wind direction is not substantially parallel to the blade surface of the turbine blade, the control center is configured to change the orientation of the blade surface to enable the turbine blade to continuously rotate to drive the column to produce electricity.
